(19) United States
(12) Patent Application Publication
(10) Pub. No.: US 2012/0098793 A1
(43) Pub. Date: Apr. 26, 2012

(54) ON-SCREEN-DISPLAY MODULE, DISPLAY DEVICE, AND ELECTRONIC DEVICE USING THE SAME

(75) Inventors: Hsin Chi Cheng, Hsinchu County (TW); Chih Hung Lu, Hsinchu County (TW); Chun Yi Lu, Hsinchu County (TW)

(73) Assignee: PIXART IMAGING INC., Hsinchu County (TW)

(21) Appl. No.: 13/013,902

(22) Filed: Jan. 26, 2011

(30) Foreign Application Priority Data
Oct. 20, 2010 (TW) 099135813

(51) Int. Cl. G06F 3/042

(52) U.S. Cl. 345/175

(57) ABSTRACT

An on-screen-display module includes an optical signal processing unit and a control unit. The optical signal processing unit receives an optical signal sensed by an image sensor and outputs a touch signal. The control unit is electrically connected to the optical signal processing unit, and adjusts a display panel to execute a corresponding display effect according to the touch signal. By applying the on-screen-display module to a display device or an electronic device, the display effect of the display panel can be directly modulated through the control unit when the host is not powered on, and advantages of further saving system energy and being convenient for a user are achieved.

### CROSS-REFERENCE TO RELATED APPLICATIONS

This non-provisional application claims priority under 35 U.S.C. §119(a) on Patent Application No(s). 099135813 filed in Taiwan, R.O.C. on Oct. 20, 2010, the entire contents of which are hereby incorporated by reference.

### BACKGROUND OF THE INVENTION

1. Field of Invention

The present invention relates to an on-screen-display module, a display device, and an electronic device using the same, and more particularly to an on-screen-display module, a display device, and an electronic device using the same that include a control unit and can directly modulate a display effect of a display panel.

2. Related Art

In recent years, with the rapid development of electronic technology, computer equipment has gradually evolved from a desktop computer to a portable notebook computer. A display (such as a screen) of the notebook computer has developed from a conventional Cathode Ray Tube (CRT) to a Liquid Crystal Display (LCD), and even to an Optical Touch Monitor (OTM). Notebook computers with smaller size and simpler operation interfaces have become a big market. Therefore, the importance of portable electronic products is obvious.

Regarding the operation of a conventional notebook computer, if a user needs to adjust a display range and brightness of the display (such as the screen), or to additionally set a recording function of a subsidiary audio/video device (such as a set-top box), the user has to adjust the functions of the display through a small screen on the apparatus. As for some electronic products that even do not have a screen, it is very inconvenient for the user to perform the adjustment.

Therefore, an On-Screen Display (OSD) develops and evolves in the market. Generally speaking, when setting a notebook computer with the OSD, the user can easily set the display or modulate each function (such as the display range and brightness) of the display through buttons on the display or a remote control, and thus, it becomes more convenient for users.

However, as regards the setting menu displayed on the screen, image data output by the OSD needs to be received, and simultaneously processed through processes such as image fusion with a main picture output by the host of the notebook computer. Afterwards, the setting menu is output on the display. Therefore, in the case that the computer host is not powered on, the functions of the conventional OSD cannot be executed, which is inconvenient for the user, and also increases the energy consumption and costs.

### SUMMARY OF THE INVENTION

Accordingly, the present invention is an on-screen-display module, a display device, and an electronic device using the same, which not only solve the problem in the conventional display that functions can be executed only when the computer host is powered on through the OSD, but also have advantages of further saving system energies and being convenient for a user.

The present invention provides an on-screen-display module, which comprises an optical signal processing unit and a control unit. The optical signal processing unit receives at least one optical signal sensed by at least one image sensor, and outputs a touch signal. The control unit is electrically connected to the optical signal processing unit, and adjusts a display panel to execute a corresponding display effect according to the touch signal.

The on-screen-display module according to the present invention further comprises a resolution modulating device, which is electrically connected between the control unit and the display panel. The resolution modulating device enables a resolution of image information to be suitable for the display panel, so as to enable the display panel to execute the corresponding display effect.

According to the on-screen-display module of the present invention, the optical signal processing unit is electrically connected to the control unit through a transmission interface, and the touch signal is output to the control unit through the transmission interface.

According to the on-screen-display module of the present invention, the transmission interface is a Serial Peripheral Interface (SPI), an Inter Integrated Circuit (I2C), or a Universal Serial Bus (USB).

According to the on-screen-display module of the present invention, the optical signal processing unit and the control unit are integrated inside a System on Chip (SOC).

The present invention further provides a display device, which comprises a display control module and an optical touch device. The display control module has a display panel and a control unit. The optical touch device is electrically connected to the control unit, and comprises at least one imaging unit and one processing unit. The imaging unit is used to sense an optical signal on the display panel, and the processing unit outputs a touch signal to the control unit according to a sensed result of the imaging unit. The control unit of the display control module adjusts the display panel to execute a corresponding display effect according to the received touch signal.

The present invention further provides an electronic device, which comprises a host and a display device. The host is used to provide image information, and the display device comprises a display control module and an optical touch device. The display control module has a display panel and a control unit, and the display panel receives the image information and displays a picture. The optical touch device is electrically connected to the control unit, and the optical touch device comprises at least one imaging unit and one processing unit. The imaging unit is used to sense an optical signal above the display panel, and the processing unit selectively outputs a touch signal to the host or the control unit according to a sensed result of the imaging unit. The host receives the touch signal to update the image information, and the control unit receives the touch signal to adjust the display panel to execute a corresponding display effect.

According to the electronic device of the present invention, if the sensed result of the imaging unit accords with a specific feature, the processing unit outputs the touch signal to the control unit, and if the sensed result does not accord with the specific feature, the processing unit outputs the touch signal to the host.

According to the electronic device of the present invention, the specific feature comprises coordinates of a sensed object being located at a specific area or continuous coordinates of a sensed object conforming to a specific locus.

Based on the above, the on-screen-display module of the present invention directly controls the execution effect of the display panel through the control unit according to the touch signal output by the optical signal processing unit. In addition, by applying the on-screen-display module to the display device of the present invention and the electronic device using the same, extra processes and steps for powering on the host in the prior art are not required, and thus, the objective of directly modulating the display effect of the display panel through the control unit is effectively achieved.

### BRIEF DESCRIPTION OF THE DRAWINGS

The present invention will become more fully understood from the detailed description given herein below for illustration only, and thus are not limitative of the present invention, and wherein:

FIG. 1A to 1C are schematic system block diagrams of an on-screen-display module according to a first embodiment of the present invention;

FIG. 2A to 2C are schematic system block diagrams of a display device according to a second embodiment of the present invention; and

FIG. 3 is a schematic system block diagram of an electronic device according to a third embodiment of the present invention.

### DETAILED DESCRIPTION OF THE INVENTION

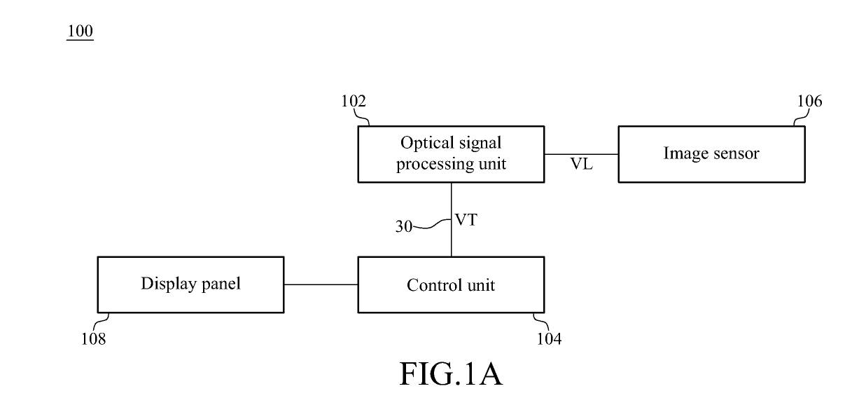

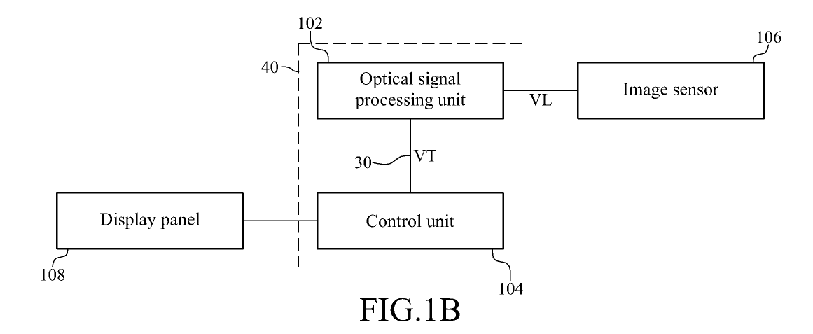

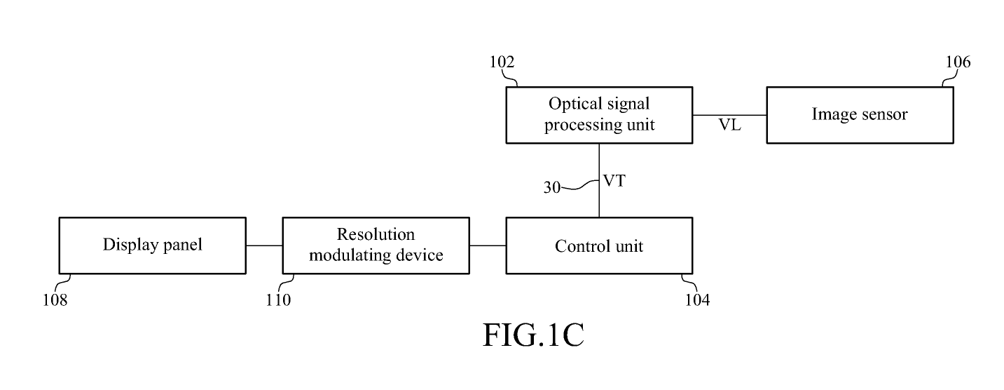

FIG. 1A is a schematic system block diagram of an on-screen-display module according to a first embodiment of the present invention. An on-screen-display module 100 comprises an optical signal processing unit 102 and a control unit 104. The optical signal processing unit 102 is electrically connected to at least one image sensor 106. Generally speaking, the image sensor 106 has a plurality of sensing pixels, and can output an optical signal VL after converting light transmitted from a scene through the sensing pixels. The optical signal processing unit 102 receives the optical signal VL and outputs a touch signal VT accordingly. The image sensor 106 may be, but is not limited to, a Complementary Metal Oxide Semiconductor (CMOS) or a Charge Coupled Device (CCD). The optical signal processing unit 102 may be, but is not limited to, a Digital Signal Processor (DSP).

For example, the image sensor 106 may be selectively set above the display panel 108 to acquire the light passing through a surface of the display panel 108. Generally speaking, the image sensor 106 may be set at each corner above the display panel 108, and determines a position of a pointer (such as a pen point and a finger tip of a user) on the display panel 108 relative to the display panel 108 through the optical signal processing unit 102. For example, the position of the pointer may be determined by, such as, estimating coordinates of an object on the display panel 108 through trigonometric functions according to an image position of the object in the image acquired by the image sensor 106. In addition, the image sensor 106 may be an infrared sensor for enhancing its sensitivity.

Therefore, according to the first embodiment of the present invention, the image sensor 106 may output the optical signal VL by detecting the pointer, so as to instruct the optical signal processing unit 102 to estimate the coordinates of the pointer (that is, to output the touch signal VT) after receiving the optical signal VL, and thus, a positioning function of the display panel 108 is achieved.

The control unit 104 is electrically connected to the optical signal processing unit 102, and may adjust the display panel 108 to execute a corresponding display effect according to the touch signal VT. In other words, when the pointer forms a dark area or a light area in brightness difference in the image acquired by the image sensor 106, the optical signal processing unit 102 may output the touch signal VT according to the sensed result of the image sensor 106, so as to instruct the control unit 104 to modulate the display effect of the display panel 108 after receiving different touch signals VT.

For example, the control unit 104 may be an OSD, which is a setting menu of the display panel 108 displayed on the screen. Generally speaking, the control unit 104 integrates quite a few modulating functions, comprising: basic functions of panel brightness, contrast, position adjustment, and even barrel distortion, trapezoid distortion, parallelogram distortion, and pincushion, all of which can be modulated and adjusted by the control unit 104. In addition, types of the display panel 108 are not used to limit the scope of the present invention. For example, the display panel 108 may be a display of digital equipment such as a television and a set-top box, a screen of a personal computer and a notebook computer, or other display panels with an integrated touch function.

According to the on-screen-display module of the first embodiment of the present invention, the optical signal processing unit 102 may be connected with the control unit 104 through a transmission interface 30. In other words, the touch signal VT may be output to the control unit 104 through the transmission interface 30. The transmission interface 30 may be, but is not limited to, an SPI (Serial Peripheral Interface), an 12C (Inter Integrated Circuit), or a USB (Universal Serial Bus).

In addition, in order to save an area occupied by the chip and production cost of an extra circuit, as shown in FIG. 1B, the optical signal processing unit 102 and the control unit 104 may be selectively integrated inside a system on chip (SOC) 40, so as to achieve the objective of SOC. In addition, as shown in FIG. 1C, the control unit 104 and the display panel 108 may further have a resolution modulating device 110, which is electrically connected between the control unit 104 and the display panel 108. Here, the resolution modulating device 110 may be a scalar integrated circuit (scalar IC) to adjust a resolution of the image information to be displayed on the display panel 108 to be suitable for the display panel 108, so that the display panel 108 may execute its corresponding display effect. For example, the resolution modulating device 110 may be, but is not limited to, a scalar IC for modulating the pixel resolution of 1024×768, 1366×768, or 1920×1080.

Therefore, according to the on-screen-display module of the first embodiment of the present invention, the control unit 104 directly modulates the display effect of the display panel 108 to achieve control of the display; alternatively, the control unit 104 may be selectively integrated into the optical signal processing unit 102 to realize the objective of SOC.

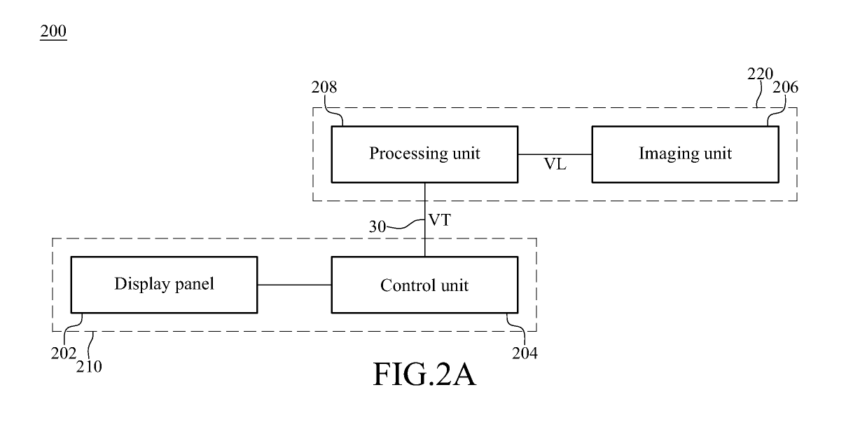

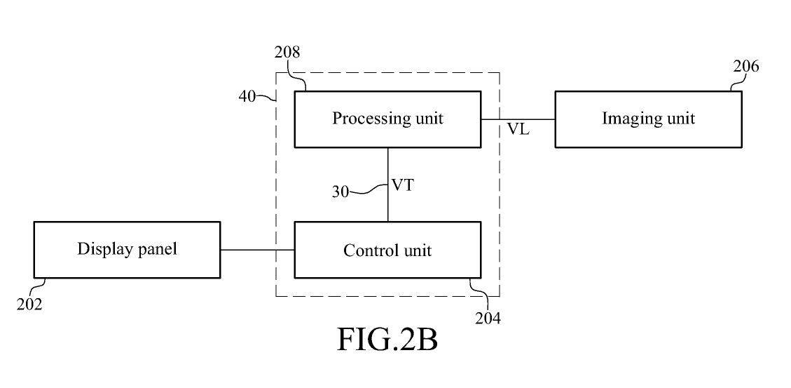

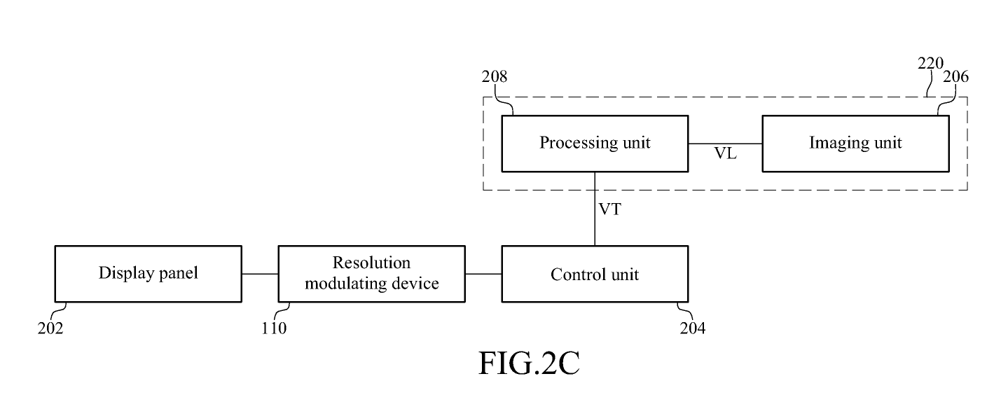

FIG. 2A is a schematic system block diagram of a display device according to a second embodiment of the present invention. Referring to FIG. 2A, a display device 200 comprises a display control module 210 and an optical touch device 220. The display control module 210 has a display panel 202 and a control unit 204. The optical touch device 220 has at least one imaging unit 206 and one processing unit 208. The display panel 202, control unit 204, imaging unit 206, and processing unit 208 are the same as the display panel 108, control unit 104, image sensor 106, and optical signal processing unit 102 in the first embodiment, and will not be described again herein.

As disclosed in the first embodiment, according to the second embodiment of the present invention, the imaging unit 206 also may be used to sense the optical signal VL above the display panel 202, and instruct the processing unit 208 to output the touch signal VT to the control unit 204 according to the sensed result (that is, to receive the optical signal VL) of the imaging unit 206. Then, the control unit 204 may modulate the display effect of the display panel 202 according to different touch signals VT. The optical touch device 220 may be, but is not limited to an OTM, and the OTM is further not limited to an infrared, optical image recognition, or embedded optical touch monitor.

As shown in FIG. 2A, the optical touch device 220 is electrically connected to the control unit 204 through a transmission interface 30. Thus, the touch signal VT may be output to the control unit 204 through the transmission interface 30. The transmission interface 30 may be, but is not limited to, an SPI, I2C, or USB.

In addition, in order to save an area occupied by the chip and production cost of an extra circuit, as shown in FIG. 2B, the processing unit 208 and the control unit 204 may be further selectively integrated inside an SOC 40, so as to achieve the objective of SOC. In addition, as shown in FIG. 2C, the control unit 204 and the display panel 202 may further have a resolution modulating device 110, so as to adjust the resolution of the image information to be displayed on the display panel 202 to be suitable for the display panel 202, so that the display panel 202 may execute its corresponding display effect. As disclosed in the first embodiment, the resolution modulating device 110 may be, but is not limited to, a scalar IC for modulating the pixel resolution of 1024×768, 1366×768, or 1920×1080, and the display panel 202 may be a display of digital equipment such as a television and a set-top box, a screen of a personal computer and a notebook computer, or other display panels with an integrated touch function.

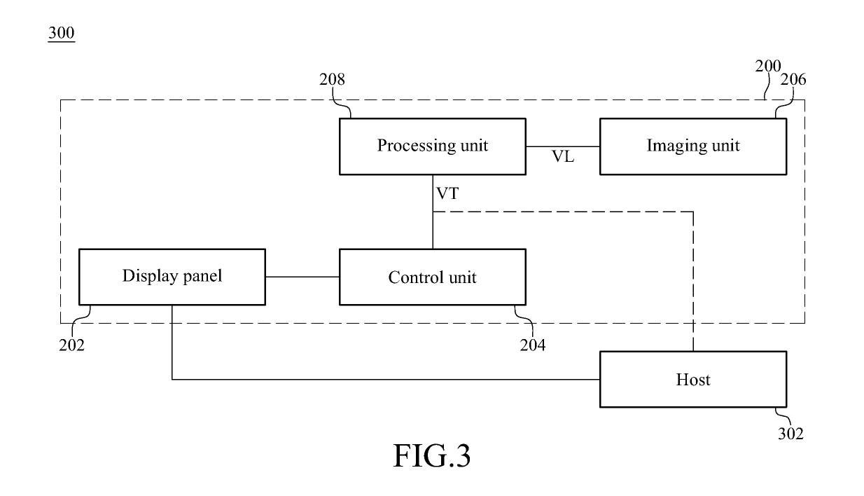

FIG. 3 is a schematic system block diagram of an electronic device according to a third embodiment of the present invention, which applies the display device 200 of the second embodiment of the present invention to the electronic device. As shown in FIG. 3, an electronic device 300 comprises a host 302 and the display device 200, in which the display device 200 is the one in the second embodiment of the present invention, and thus will not be described herein.

According to the third embodiment of the present invention, the processing unit 208 is electrically connected to the control unit 204 and the host 302. Thus, the processing unit 208 may selectively output the touch signal VT to the control unit 204 or the host 302. The host 302 may be used to provide image information, so as to instruct the display panel 202 to display a picture after receiving the image information.

Therefore, after the host 302 receives the touch signal VT, the host 302 may update the image information, so as to instruct the display panel 202 to display a picture after receiving the image information. In stead, while the control unit 204 receives the touch signal VT, as disclosed in the second embodiment of the present invention, the control unit 204 may modulate the display effect of the display panel 202 according to different touch signals VT.

The processing unit 208 determines whether to output the touch signal VT to the host 302 or the control unit 204 by determining whether the sensed result of the imaging unit 206 accords with a specific feature. In other words, if the imaging unit 206 senses that a pointer appears in a specific area of the display panel 202 (that is, the imaging unit 206 detects coordinates of an object), or if the imaging unit 206 senses that the pointer has continuous coordinates, and the continuous coordinates accord with a specific locus (comprising multi-touch), the processing unit 208 outputs the touch signal VT to the control unit 204; otherwise, the processing unit 208 outputs the touch signal VT to the host 302.

Therefore, according to the electronic device of the third embodiment of the present invention, since the processing unit 208 may selectively output the touch signal VT to the host 302 or the control unit 204 according to the sensed result of the imaging unit 206, in the electronic device 300, the display panel 202 can still modulate the executed display effect (such as the panel brightness, contrast, position adjustment, image distortion, or pincushion) under the control of the control unit 204 even if the host 302 is not activated. Based on the above, the on-screen-display module, display device and electronic device according to the first, second, and third embodiments of the present invention not only eliminate the limitation in the conventional display that functions can be executed only when the computer host is powered on, but also achieve the objectives of saving system energy and being convenient for a user.

What is claimed is:

1. An on-screen-display module, comprising:
an optical signal processing unit, for receiving at least one optical signal sensed by at least one image sensor and outputting a touch signal; and
a control unit, electrically connected to the optical signal processing unit, for adjusting a display panel to execute a corresponding display effect according to the touch signal.

2. The on-screen-display module according to claim 1, further comprising a resolution modulating device electrically connected between the control unit and the display panel, wherein the resolution modulating device enables a resolution of image information to be suitable for the display panel, so as to instruct the display panel to execute the corresponding display effect.

3. The on-screen-display module according to claim 1, wherein the optical signal processing unit is electrically connected to the control unit through a transmission interface, and the touch signal is output to the control unit through the transmission interface.

4. The on-screen-display module according to claim 3, wherein the transmission interface is a Serial Peripheral Interface (SPI).

5. The on-screen-display module according to claim 3, wherein the transmission interface is an Inter Integrated Circuit (I2C).

6. The on-screen-display module according to claim 3, wherein the transmission interface is a Universal Serial Bus (USB).

7. The on-screen-display module according to claim 1, wherein the optical signal processing unit and the control unit are integrated inside a System on Chip (SOC).

8. The on-screen-display module according to claim 1, wherein the image sensor is disposed above the display panel for acquiring light passing through a surface of the display panel.

9. A display device, comprising:
a display control module, having a display panel and a control unit; and
an optical touch device, electrically connected to the control unit of the display control module, wherein the optical touch device comprises at least one imaging unit and a processing unit, the imaging unit is used to sense an optical signal above the display panel, and the processing unit outputs a touch signal to the control unit according to a sensed result of the imaging unit;
wherein the control unit of the display control module modulates the display panel to execute a corresponding display effect according to the received touch signal.

10. The display device according to claim 9, further comprising a resolution modulating device electrically connected between the control unit and the display panel, wherein the resolution modulating device enables a resolution of image information to be suitable for the display panel, so as to instruct the display panel to execute the corresponding display effect.

11. The display device according to claim 9, wherein the optical touch device is electrically connected to the control unit through a transmission interface, and the touch signal is output to the control unit through the transmission interface.

12. The display device according to claim 11, wherein the transmission interface is a Serial Peripheral Interface (SPI).

13. The display device according to claim 11, wherein the transmission interface is an Inter Integrated Circuit (I2C).

14. The display device according to claim 11, wherein the transmission interface is a Universal Serial Bus (USB).

15. The display device according to claim 9, wherein the processing unit of the optical touch device and the control unit are integrated inside a System on Chip (SOC).

16. An electronic device, comprising:
a host, for providing image information; and
a display device, comprising: a display control module, having a display panel and a control unit, wherein the display panel receives the image information and displays a picture; and an optical touch device electrically connected to the control unit of the display control module, comprising at least one imaging unit and a processing unit, wherein the imaging unit is used to sense an optical signal above the display panel, and the processing unit selectively outputs a touch signal to the host or the control unit according to a sensed result of the imaging unit; when the host receives the touch signal, it updates the image information, and when the control unit of the display control module receives the touch signal, it adjusts the display panel to execute a corresponding display effect.

17. The electronic device according to claim 16, wherein the display device further comprises a resolution modulating device electrically connected to the display panel, the control unit and the host, wherein the resolution modulating device enables a resolution of the image information to be suitable for the display panel, so as to instruct the display panel to execute the corresponding display effect.

18. The electronic device according to claim 16, wherein the optical touch device is electrically connected to the control unit through a transmission interface, and the touch signal is output to the control unit through the transmission interface.

19. The electronic device according to claim 18, wherein the transmission interface is a Serial Peripheral Interface (SPI).

20. The electronic device according to claim 18, wherein the transmission interface is an Inter Integrated Circuit (I2C).

21. The electronic device according to claim 18, wherein the transmission interface is a Universal Serial Bus (USB).

22. The electronic device according to claim 16, wherein the processing unit of the optical touch device and the control unit are integrated inside a System on Chip (SOC).

23. The electronic device according to claim 16, wherein when the sensed result of the imaging unit accords with a specific feature, the processing unit outputs the touch signal to the control unit, and if the sensed result does not accord with the specific feature, the processing unit outputs the touch signal to the host.

24. The electronic device according to claim 23, wherein the specific feature of the sensed result comprises coordinates of a sensed object being located at a specific area of the display panel or continuous coordinates of a sensed object conforming to a specific locus.
